(19) United States
(12) Patent Application Publication
(10) Pub. No.: US 2008/0035393 A1
(43) Pub. Date: Feb. 14, 2008

(54) Coordinate input apparatus

(75) Inventors: Naoyuki Hatano, Fukushima-ken (JP); Shinji Hirano, Fukushima-ken (JP); Katsuichi Oba, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/881,559

(22) Filed: Jul. 27, 2007

(30) Foreign Application Priority Data
Aug. 10, 2006 (JP) 2006-218328

(51) Int. Cl. G06F 3/041

(52) U.S. Cl. 178/18.03

(57) ABSTRACT

A coordinate input apparatus is provided that consumes little power and is capable of properly inputting coordinates without being influenced by a surrounding environment change. The coordinate input apparatus 21 has pressure sensors 3a, 3b, 3c, 3d, and 3e that are composed of registers and detect the pressure applied at the time of operation as voltage changes. A switching element 23, 31 that on/off controls a voltage to be applied to the pressure sensors 3a, 3b, 3c, 3d, and 3e is provided on the power source side of the pressure sensors 3a, 3b, 3c, 3d, and 3e.

### RELATED APPLICATIONS

This application claims the priority of priority under 35 U.S.C. §119 to Japanese Patent Application No. 2006-218328, filed on Aug. 10, 2006, which is hereby incorporated by reference.

### BACKGROUND

1. Field of the Disclosure

The present disclosure relates to a coordinate input apparatus, and specifically, relates to a coordinate input apparatus with use of a pressure sensor.

2. Description of the Related Art

Conventionally, a coordinate input apparatus using a pressure sensor has been widely used as an input device of a computer, etc.

Various kinds of configurations are suggested as such a coordinate input apparatus. The present applicant has suggested a coordinate input apparatus capable of performing input with high sensitivity (refer to JP-A-2004-048121).

FIGS. 6 to 8 show one example of the coordinate input apparatus based on the present applicant's suggestion. The coordinate input apparatus of FIGS. 6 to 8 is formed so that two-dimensional (X-Y) coordinates can be made. FIGS. 6 and 7 show the mechanical configuration, and FIG. 8 shows the configuration of a detection circuit. To describe the coordinate input apparatus, a substantially cross-like sensor unit 3 having four rectangular pressure sensors 3a, 3b, 3c, and 3d that are composed of resistors. A flexible substrate 2 is placed on a substantially circular placing part 1a at the center of a board 1 that is secured to a computer or computing device. A flat, disk-like substrate member 4 having flexibility and composed of a molded product of synthetic resin, for instance, is placed on the sensor unit 3. Four clips 5 that are formed at intervals of 90 degrees at the outer periphery of, and extended from, the placing part 1a as shown in FIG. 7. The clips 5 are bent onto the substrate member 4 to fix the board 1, the flexible substrate 2, and the substrate member 4 to each another.

A central shaft (not shown) is provided on the central bottom surface of the operating member 6 so as to protrude therefrom. A substantially circular operating member 6 is placed on the substrate member 4 by loosely inserting the central shaft into a central hole 4h of the substrate member 4 and into a central hole 2h of the flexible substrate 2, and by covering a flange 6a of the operating member 6 with a cover member (not shown) so that the position of the operating member 6 does not deviate. The four pressure sensors 3a, 3b, 3c, and 3d of the flexible substrate 2 are disposed at intervals of 90 degrees, and the flexible beam parts 4a, 4b, 4c, and 4d of the substrate member 4 are disposed in positions above respective pressure sensors 3a, 3b 3c, and 3d. In order to space apart the beam parts 4a, 4b, 4c, and 4d, substantially V-shaped holes 7 are formed. Projections 8a, 8b, 8c, and 8d are formed on the top surfaces of the respective beam parts 4a, 4b, 4c, and 4d.

Circuits of the four pressure sensors 3a, 3b, 3c, and 3d, as shown in FIGS. 6 and 8, are arranged so that two sets of pressure sensors 3a, 3b and 3c, 3d that face each other in diametrical positions across the center of the sensor unit, may output an X-axis coordinate and a Y-axis coordinate, respectively. As shown in FIG. 8, a reference voltage is always applied to the pressure sensors 3a, 3b, 3c, and 3d from a reference voltage source 9. Then, when an operating member 6 is operated so as to be pressed downward, the beam parts 4a, 4b, 4c, and 4d are pressed downward and deflected via the projections 8a, 8b, 8c, and 8d corresponding to the pressing force, and voltage changes generated in the pressure sensors 3a, 3b, 3c, and 3d are output to an X-axis output unit 11 and an Y-axis output unit 12, thereby inputting coordinates.

FIGS. 9 to 11 show another example of the coordinate input apparatus based on the present applicant's suggestion. The coordinate input apparatus of FIGS. 9 to 11 is formed so that three-dimensional (X-Y-Z) coordinates can be made. FIGS. 9 and 10 show the mechanical configuration of a different example, and FIG. 11 shows the configuration of a detecting circuit.

The coordinate input apparatus of FIG. 9 will now be described mainly in regards to the features that are different from the example shown in FIGS. 6 and 7. In addition to the four pressure sensors 3a, 3b, 3c, and 3d of the flexible substrate 2, a pressure sensor 3e for the Z-axis is provided in the central hole 2h. The operating member 6 is formed so that the pressure sensor 3e may be pressed by a central shaft 6h positioned so as to perforate the bottom surface of the operating member 6. An annular outside operating member 13 includes a bottom surface that faces the four projections 8a, 8b, 8c, and 8d of the substrate member 4, and is located in an outer peripheral position of the operating member 6 such that its inner periphery is placed on the flange 6a of the operating member 6. At the outer periphery of the outside operating member 13, a cover member 14 is covered on the flange 6a of the outside operating member 13 so that the position of the outside operating member 13 may not deviate. The other configurations are formed similarly to the coordinate input apparatus shown in FIGS. 6 and 7.

In the coordinate input apparatus of FIG. 10, the four projections 8a, 8b, 8c, and 8d of the coordinate input apparatus of FIG. 9 are omitted, and four projections 15a, 15b, 15c, and 15d are instead provided on the bottom surface of the outside operating member 13.

In the coordinate input apparatus shown in FIGS. 9 and 10, circuits of the five pressure sensors 3a, 3b, 3c, 3d, and 3e are arranged as shown in FIG. 11. Switching to four pressure sensors 3a, 3b, 3c, and 3d for the X-Y-axis outputs and one pressure sensor 3e for the Z-axis output is arranged so that an electric current can be applied thereto via a multiplexer 15 from the reference voltage source 9. The multiplexer 15 is formed so that its contact point 15a can switch between two terminals 15b and 15c upon receiving a multiplexer switching signal output from the signal processing IC chip 10. One pressure sensor 3e for one Z-axis output and four pressure sensors 3a, 3b, 3c, and 3d for the X-Y-axis outputs are connected in series to one terminal 15b. A connection point between the pressure sensor 3e for the Z-axis output and the four pressure sensors 3a, 3b, 3c, and 3d for the X-Y-axis outputs is connected to the other terminal 15C. A signal is output to a Z-axis input unit 16 provided in the signal processing IC chip 10 from this connection point. The other configurations are formed similarly to the circuit shown in FIG. 8.

The conventional coordinate input apparatus shown in FIGS. 8 and 11 has disadvantages in that, since an electric current is always applied to the pressure sensors 3a, 3b, 3c, 3d, and 3e from the reference voltage source 9, power consumption increases, and consequently, the consumption rate of a battery is high. This may be a battery power source of a personal computer, for instance.

### SUMMARY

The disclosure has been made in view of these points. It is therefore an object of the disclosure to provide a coordinate input apparatus with little power consumption.

Further, another object of the disclosure is to provide a coordinate input apparatus that consumes little power and is capable of properly inputting coordinates without being influenced by a change in surrounding environment.

In order to achieve these objects, the coordinate input apparatus includes pressure sensors that are composed of registers and detect the pressure applied at the time of operation as voltage changes. Here, a switching element controls the on/off state of a voltage to be applied to the pressure sensors, and is provided on the power source side of the pressure sensors.

According to a coordinate input apparatus of the disclosure, the power consumption of the coordinate input apparatus can be greatly reduced by on/off controlling a voltage to be applied to the pressure sensors by the switching element.

Further, a switching element that on/off controls a voltage to be applied to the pressure sensors is provided on the power source side of the pressure sensors, and when the characteristics of the switching element have changed due to a surrounding environmental change, an offset means that offsets the change is provided on the grounding side of the pressure sensors.

According to a coordinate input apparatus of the disclosure, the power consumption of the coordinate input apparatus can be greatly reduced by on/off controlling a voltage to be applied to the pressure sensors by the switching element. Moreover, even when the characteristics of the switching element have changed due to a surrounding environmental change, the offset means offsets such a change. Thus, the detection output of the pressure sensors becomes proper.

Further, in a coordinate input apparatus according to the disclosure, the switching element and the offset means are disposed close to each other within the same IC chip. Additionally, the switching element and the offset means will experience almost the same environmental change. As a result, the offset effect by the offset means is properly exhibited, thereby making the detection output of the pressure sensors proper. Further, the offset means is formed of the same object as the switching element.

According to a coordinate input apparatus of the disclosure, the offset means and the switching element are formed of the same object. Thus, both the offset means and the switching element undergo the influence of the same environmental change and change equally in response. The influence on the pressure sensors disappears, and consequently the detection output of the pressure sensors becomes more accurate.

Further, in one embodiment, the switching element is formed of a field-effect transistor (FET), which causes each effect to be exhibited more accurately. Further, a switching element provided on the power source side of the pressure sensors is formed of a P-type transistor, and a switching element provided on the grounding side of the pressure sensors is formed in an N-type transistor. Two P-type and N-type FETs may undergo the influence of the same environmental change and thus change equally. The influence on the pressure sensors disappears, and consequently, the detection output of the pressure sensors becomes more accurate.

### BRIEF DESCRIPTION OF THE DRAWINGS

FIG. 1 is a circuit diagram showing a first embodiment of a coordinate input apparatus of the disclosure.

FIG. 2 is a circuit diagram showing a second embodiment of the coordinate input apparatus of the disclosure.

FIG. 3 is an equivalent circuit diagram of the first embodiment of the coordinate input apparatus of the disclosure.

FIG. 4 is an equivalent circuit diagram of the second embodiment of the coordinate input apparatus of the disclosure.

FIG. 5 is a circuit diagram showing a third embodiment of the coordinate input apparatus of the disclosure.

FIG. 6 is an exploded perspective view showing an example of a conventional coordinate input apparatus.

FIG. 7 is an assembled perspective view of the conventional example of FIG. 6.

FIG. 8 is a circuit diagram showing an example of the conventional coordinate input apparatus.

FIG. 9 is a half-cut perspective view showing another example of the conventional coordinate input apparatus.

FIG. 10 is a half-cut perspective view showing still another example of the conventional coordinate input apparatus.

FIG. 11 is a circuit diagram showing another example of the conventional coordinate input apparatus.

### DESCRIPTION OF THE PREFERRED EMBODIMENT

Hereinafter, embodiments of a coordinate input apparatus according to the disclosure will be described with reference to the accompanying drawings.

### First Embodiment

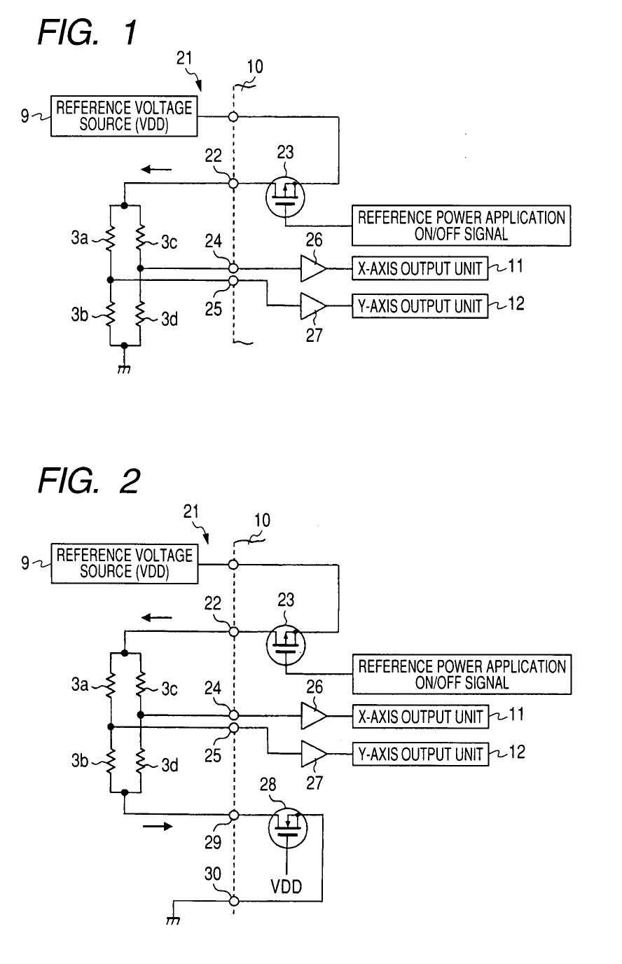

FIG. 1 shows a circuit configuration of a first embodiment of the disclosure. The present embodiment is formed so that two-dimensional (X-Y) input can be made, and the same reference numerals are given to the same parts as in the conventional ones, discussed above.

In a coordinate input apparatus 21 of the present embodiment, four pressure sensors 3a, 3b, 3c, and 3d are disposed outside a signal processing IC chip 10. That is, two sets of pressure sensors 3a, 3b and 3c, 3d are connected in parallel so as to output an Y-axis coordinate and a X-axis coordinate, respectively. One end of each of the sets is grounded, and the other end thereof is connected to an output terminal 22 of the signal processing IC chip 10.

A field-effect transistor (FET) 23 is one example of a switching element that on/off controls a voltage applied to the pressure sensors 3a, 3b, 3c, and 3d. The FET 23 is formed between a reference voltage source 9 and the output terminal 22. As shown, the FET 23 is a P-type. The FET has a reference power application ON/OFF signal supplied to the gate thereof, whereby the FET is on/off controlled. Further, a connection point between the set of pressure sensors 3c and 3d and a connection point between the set of pressure sensors 3a and 3b are connected to input terminals 24 and 25 of the signal processing IC chip 10, respectively. The connection points are formed so as to output detection voltages to an X-axis output unit 11 and a Y-axis output unit 12 via amplifiers 26 and 27, respectively.

In the first embodiment, when coordinates are input, a reference power application ON signal is supplied to the gate of the FET 23, the FET 23 is turned on, and a reference voltage VDD is applied to the four pressure sensors 3a, 3b, 3c, and 3d from the reference voltage source 9. In this state, when an operating member 6 is operated so as to be pressed downward, beam parts 4a, 4b, 4c, and 4d are pressed downward and deflected via projections 8a, 8b, 8c, and 8d corresponding to the pressing force. Then, voltage changes generated in the pressure sensors 3a, 3b, 3c, and 3d, specifically, changes in the division ratio of voltages in the two sets of pressure sensors 3c, 3d and 3a, 3b are output, are amplified by the amplifiers 26 and 27, and are input to the X-axis output unit 11 and the Y-axis output unit 12, thereby inputting coordinates.

Further, when coordinates are not input, a reference power application OFF signal is supplied to the gate of the FET 23, the FET 23 is turned off, and application of a reference voltage VDD from the reference voltage source 9 is blocked.

As described above, according to the present embodiment, since a voltage to be applied to the four pressure sensors 3a, 3b, 3c, and 3d can be on/off controlled by the FET 23, the power consumption of the coordinate input apparatus 21 can be reduced greatly. Further, since the FET 23 is used as a switching element, it can be integrally formed within the signal processing IC chip 10 when the latter is manufactured.

### Second Embodiment

FIG. 2 shows a circuit configuration of a second embodiment of the disclosure. This embodiment is formed so that a two-dimensional (X-Y) input can be made, and an N-type FET 28 is also used as a switching element on the grounding side of the four pressure sensors 3a, 3b, 3c, and 3d in the first embodiment. The other configurations are formed similarly to those of the first embodiment.

More specifically, the FET 28 is integrally formed within the signal processing IC chip 10 between an input terminal 29 and an output terminal 30 of the signal processing IC chip 10. The FET 28 has a reference voltage always applied to the gate thereof, whereby the FET 28 is turned on. The ends of the four pressure sensors 3a, 3b, 3c, and 3d on their grounding side is connected to the input terminal 29, and the output terminal 30 is grounded.

In the second embodiment, when coordinates are input, a reference power application ON signal is supplied to the gate of the FET 23, the FET 23 is turned on, and a reference voltage VDD is applied to the four pressure sensors 3a, 3b, 3c, and 3d and the FET 28 from the reference voltage source 9. In this state, when an operating member 6 is operated so as to be pressed downward, beam parts 4a, 4b, 4c, and 4d are pressed downward and deflected via projections 8a, 8b, 8c, and 8d corresponding to the pressing force. Then, voltage changes generated in the pressure sensors 3a, 3b, 3c, and 3d, specifically, changes in the division ratio of voltages in the two sets of pressure sensors 3c and 3d and pressure sensors 3a and 3b are output, are amplified by the amplifiers 26 and 27, and are input to the X-axis output unit 11 and the Y-axis output unit 12, thereby inputting coordinates.

Further, when coordinates are not input, a reference power application OFF signal is supplied to the gate of the FET 23 to turn off the FET 23, thereby blocking application of a reference voltage VDD from the reference voltage source 9.

As described above, according to the second embodiment, since a voltage to be applied to the four pressure sensors 3a, 3b, 3c, and 3d can be on/off controlled by the FET 23, the power consumption of the coordinate input apparatus 21 can be reduced greatly. Further, since the FETs 23 and 28 are used as switching elements, they can be integrally formed within the signal processing IC chip 10 when the later is manufactured.

Moreover, in the second embodiment, the FET 23 that on/off controls a voltage to be applied to the pressure sensors 3a, 3b, 3c, and 3d is provided on the power source side of the pressure sensors 3a, 3b, 3c, and 3d, and when the characteristics of the FET 23 have changed due to a surrounding environmental change.

Additionally, the FET 28 serves as an offset means for offsetting such a change, which provided on the grounding side of the pressure sensors 3a, 3b, 3c, and 3d. Thus, even when the characteristics of the FET 23 change due to a surrounding environmental change, the FET 28 serves as an offset means to offset such a change. Thus, the detection output of the pressure sensors 3a, 3b, 3c, and 3d becomes proper. As such, from a surrounding environmental change, the fluctuation of the reference voltage VDD and a temperature change can be exemplified. Such environmental changes offset each other because they equally act on the ON resistances of the two FETs 23 and 28. As a result, the fluctuation of the output (voltages divided by two registers) from the pressure sensors 3a, 3b, 3c, and 3d become small when compared with that of the first embodiment of FIG. 1.

More specifically, for example, suppose that the ON resistances of the FETs 23 and 28 are several ohms (Ω) to several tens of ohms (Ω). Changes in the resistance values of the pressure sensors 3a 3b, 3c, and 3d at the time of input are several millimeter ohms (Ω) to several tens of ohms (Ω). In such relationship, if only the FET 23 serving as one switching element is provided without providing an offset means, the fluctuation of the ON resistance of the FET 23 from several tens of millimeter ohms (Ω) to several tens of ohms (Ω) caused by a power voltage change or a temperature change cannot be distinguished from the resistance changes of the pressure sensors 3a, 3b, 3c, and 3d. Therefore, malfunction may occur in detection. However, by providing the FET 28 as another offset means, the fluctuation of the ON resistance of the FET 23 can be offset.

Furthermore, like the above embodiments, the switching element 23 and the offset means 28 are disposed close to each other in the same signal processing IC chip 10. Thus, the switching element 23 and the offset means 28 will experience almost the same environmental change. As a result, the offset effect by the offset means 28 is properly exhibited, thereby making the detection output of the pressure sensors 3a, 3b, 3c, and 3d more accurate.

Furthermore, like the above embodiments, the offset means 28 is formed of the same object (e.g., an FET) as the switching element 23. Thus, both the offset means and switching element (FETs 23 and 28) equally undergo the influence of the same environmental change. The influence on the pressure sensors 3a, 3b, 3c, and 3d disappears, and consequently, the detection output of the pressure sensors 3a, 3b, 3c, and 3d becomes more accurate. Furthermore, by using the FET 23 as a switching element, each effect will be exhibited more properly.

Furthermore, in the above embodiments, the FET 23 serving as a switching element provided on the power source side of the pressure sensors 3a, 3b, 3c, and 3d may be formed in a P-type transistor, and the FET 28 serving as an offset means provided on the grounding side of the pressure sensors 3a, 3b, 3c, and 3d may be formed in an N-type transistor. Thus, the P-type and N-type FETs 23 and 28 undergo the influence of the same environmental change, and thereby change equally. As a result, the influence on the pressure sensors 3a, 3b, 3c, and 3d disappear further, and thus the detection output of the pressure sensors 3a, 3b, 3c, and 3d becomes more proper.

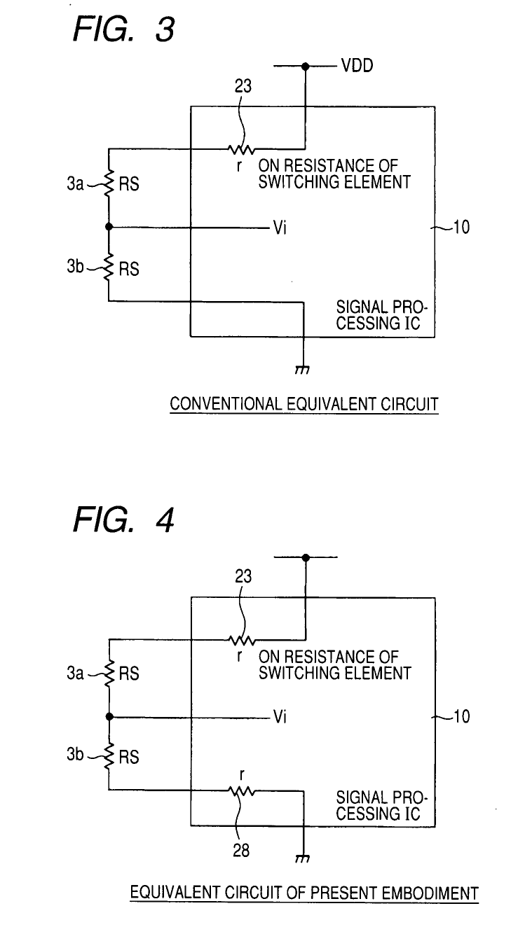

FIGS. 3 and 4 are equivalent circuit diagrams of the first embodiment and the second embodiment.

Here, the resistance value of each of the pressure sensors 3a, 3b, and 3c, and 3d is set to “RS,” and the ON resistances of the FETs 23 and 28 serving as a switching element and an offset means are set to “r.”

In the first embodiment of FIG. 3, the FET 23 is provided on the power supply side of the pressure sensors 3a, 3b, 3c, and 3d. Therefore, the input voltage Vi of an IC the voltage of which is divided by a register becomes Vi={RS/(2RS+r)}×VDD.

Here, supposing the ON resistance of the FET 23 has changed by +αΩ, input voltage Vi′ becomes

Vi′={RS/(2RS+r+α)}×VDD,

and voltage fluctuation value ΔVI=(Vi−Vi′) becomes

ΔVI=(Vi−Vi′)={αRS/(2RS+r) (2RS+r+α)}

In contrast, if the calculation similar to the above is made in the second embodiment of FIG. 4, the results are as follows:

Vi=(½)×VDD;

Vi′=(½)×VDD; and

ΔVI=(Vi−Vi′)=0.

### As a result, the voltage fluctuation of the pressure sensors 3a 3b, 3c, and 3d of the second embodiment will be suppressed low.

In addition, for the purpose of simplification of the calculation expressions, all the resistances of the sensors 3a, 3b, 3c, and 3d are set to RS, and all the ON resistances of the switching elements are set to r. However, in actuality, the resistances have variations, and are therefore usually not the same.

### Third Embodiment

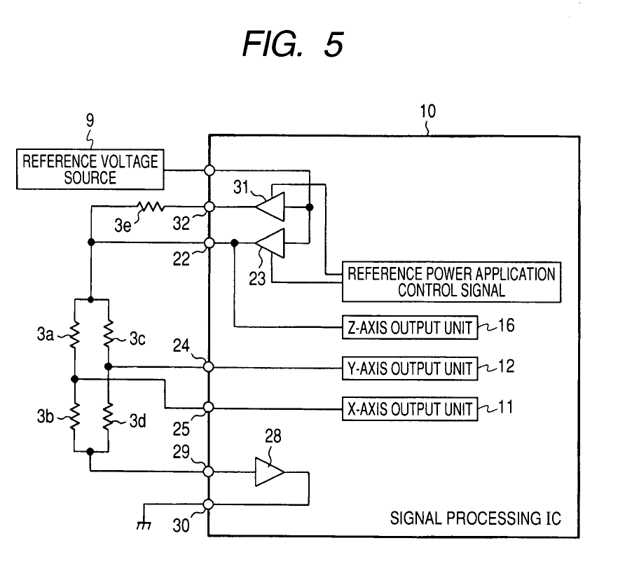

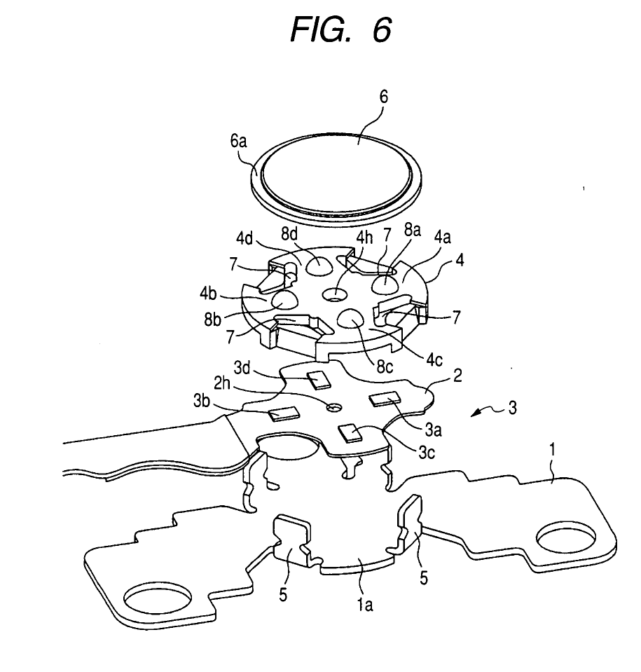

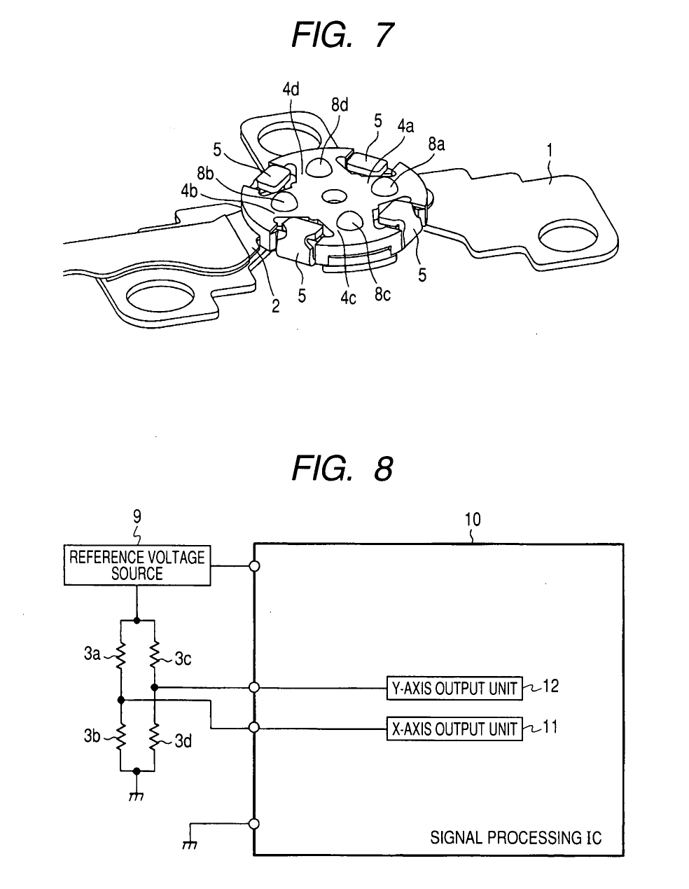

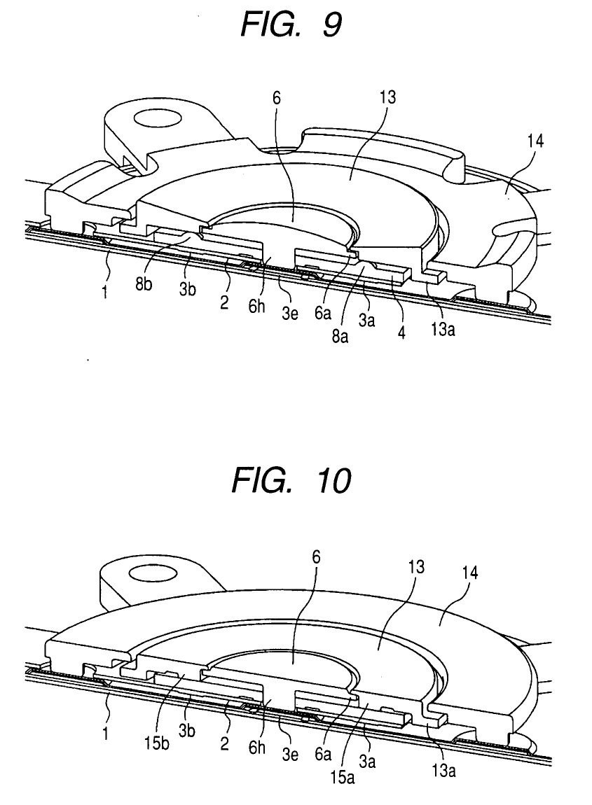

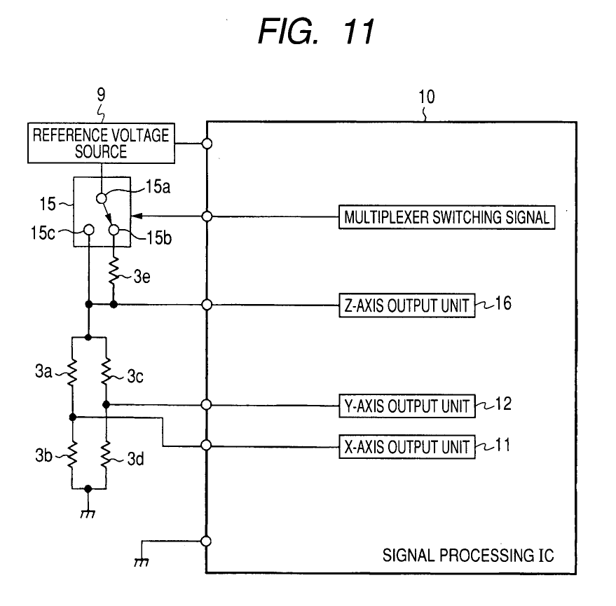

FIG. 5 shows a circuit configuration of a third embodiment of the disclosure. The present embodiment is formed so that a three-dimensional (X-Y-Z) input can be made, and an FET 31 as a switching element is provided on the side of the reference voltage source of the four pressure sensors 3a, 3b, 3c, and 3d in the second embodiment. The other configurations are formed similarly to those of the second embodiment.

More specifically, the FET 31 is integrally formed within the signal processing IC chip 10 between the input terminal 31 of the signal processing IC chip 10 and the reference voltage source 9. The FET 31 has a reference voltage application ON/OFF signal supplied to the gate thereof, whereby the FET is on/off controlled. A pressure sensor 3e is connected to the output terminal 32 of the signal processing IC chip 10, and to ends of the four pressure sensors 3a, 3b, 3c, and 3d on the side of the reference voltage source thereof.

Since the two-dimensional operation of the X-Y axes is the same as that of the second embodiment, only the operation of the Z-axis will be described herein.

In the present embodiment, when the coordinate of the Z axis is input, a reference power application ON signal is supplied to the gate of the FET 31, the FET 31 is turned on, and a reference voltage VDD is applied to the pressure sensor 3e, to the four pressure sensors 3a, 3b, 3c, and 3d, and to the FET 28 from the reference voltage source 9. The other FET 23 is turned off. In this state, if the operating member 6 is pressed downward, and a pressing force is applied to the pressure sensor 3e, a voltage change generated from the pressure sensor 3e is output from a connection point between the pressure sensor 3e and the four pressure sensors 3a, 3b, 3c, and 3d, and is input to a Z-axis output unit 16 provided in the signal processing IC chip 10 via the output terminal 22, thereby inputting a coordinate.

Further, when coordinates are not input, a reference power application OFF signal is supplied to the gate of the FET 31 to turn off the FET 31, thereby blocking application of a reference voltage VDD from the reference voltage source 9.

Thus, in the third embodiment, the three-dimensional input is excellently performed.

In addition, the disclosure is not limited to the above embodiments, and various changes thereof can be made, if necessary.

For example, switching elements other than the FET can be used as the switching elements 23 and 31 and the offset means 28. Further, since it is preferable that ON resistance always exist as an offset means 28, a resistor can be used.

1. A coordinate input apparatus having pressure sensors that are composed of registers and detect the pressure applied at the time of operation as voltage changes,
wherein a switching element that on/off controls a voltage to be applied to the pressure sensors is provided on a power source side of the pressure sensors.

2. The coordinate input apparatus according to claim 1, wherein switching elements are disposed close to each other within the same IC chip.

3. The coordinate input apparatus according to claim 1, wherein the switching element comprises an FET.

4. A coordinate input apparatus having pressure sensors that are composed of registers and detect the pressure applied at the time of operation as voltage changes,
wherein a switching element that on/off controls a voltage to be applied to the pressure sensors is provided on a power source side of the pressure sensors, and when the characteristics of the switching element have changed due to a surrounding environmental change, an offset means that offsets the change is provided on a grounding side of the pressure sensors.

5. The coordinate input apparatus according to claim 4, wherein the switching element and the offset means are disposed close to each other within the same IC chip.

6. The coordinate input apparatus according to claim 4, wherein the offset means comprises the same object as the switching element.

7. The coordinate input apparatus according to claim 4, wherein the switching element comprises an FET.

8. The coordinate input apparatus according to claim 4, wherein the offset means comprises an FET.

9. The coordinate input apparatus according to claim 4, wherein the switching element provided on the power source side of the pressure sensors is formed as a P-type transistor, and the switching element provided on the grounding side of the pressure sensors is formed as an N-type transistor.
